(19) United States
(12) Patent Application Publication
(10) Pub. No.: US 2003/0235517 A1
(43) Pub. Date: Dec. 25, 2003

(54) Incubation device

(76) Inventors: Holgar Deppe, Frankfurt (DE); Beate Diefenbach, Munich (DE); Andreas Willems, Seligenstadt (DE); Hanns Wurziger, Darmstadt (DE); Alexander Gross, Neubrueckerweg (DE); Gregor Schlingloff, Klein Gerau (DE); Andreas Schober, Darmstadt (DE); Dirk Tomadl, Leimen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/380,669

(22) PCT Filed: Aug. 23, 2001
(86) PCT No.: PCT/EP01/09747

(30) Foreign Application Priority Data
Sep. 19, 2000 (DE) 100462243

(51) Int. Cl. B01L 3/00

(52) U.S. Cl. 422/99; 422/104

(57) ABSTRACT

A device for carrying out the parallel incubation of solutions comprises a holding frame (1) inside of which one or more titer plates (2) can be placed. Each titer plate (2) is separately closed by a cover plate (4), which can be pressed thereon, resulting in the prevention of unwanted evaporation effects and transport phenomena. Seals (5) are placed between the cover plate (4) and the holding frame (1). Continuous recesses in the holding frame (1) are located underneath the titer plates (2) and are occluded by a common one-piece bottom plate (7) having punch-like protrusions (6). Devices for regulating temperature can be arranged both inside the cover plate (4), the holding frame (1) as well as inside the one-piece bottom plate (7). The holding frame (1) comprises channel-like recesses for accommodating liquid solvent.

The invention relates to a device for the parallel incubation of solutions.

Prompted by promising developments and research results, the interest in biological, biochemical and organochemical processes and methods is constantly increasing. Both for complex research projects and for the industrial production and analysis of biological or chemical substances, ever-faster processing of an ever-increasing number of samples is required. This increasing demand requires efficient and inexpensive methods which can be carried out in parallel for the largest possible number of samples. At the same time, it is being attempted to reduce to a minimum the amount of biological and chemical substances needed for the method.

Instead of individual test tubes, it has now become usual to combine a large number of small reaction containers arranged in matrix form to give reaction units. Even greater miniaturisation of the individual reaction containers is achieved by utilising small cavities recessed in a plate as reaction cavities. Titer plates of this type may consist, for example, of a photostructured glass plate or a surface-treated plastic plate. Titer plates are also known in which a chip made of silicon has a large number of small, regularly arranged cavities. For some applications, it is advantageous for the individual reaction cavities to have a complex shape. Depending on the characteristic dimensions of the titer plate, it is also known as a microtiter plate or nanotiter plate. The individual reaction cavities have volumes which can be used for samples in the range from millilitres to a few microlitres, while in nanotiter plates volumes in the nanolitre range are achieved.

The miniaturisation achieved in this way enables increasing parallelisation of individual method steps and at the same time reduces the costs constantly arising for the purchase and disposal of the chemical substances and solvents consumed in the process.

Increasing sample throughput also makes the most comprehensive possible automation of individual method steps necessary. In particular, constantly repeating processes, for example the filling and emptying of individual reaction cavities, are usually carried out in a completely automated manner. Individual reaction cavities, entire titer plates and the devices and instruments needed in the method must therefore also, through their shape, enable automated handling of the samples during the method.

The smaller the useful volume of individual reaction cavities, the greater the extent to which evaporation effects that occur can affect the progress of the method, or give incorrect results in quantitative analyses. Interfering evaporation effects occur, in particular, during incubation of samples at elevated temperature. If the individual sample volume is reduced to a few microlitres or less, incubation is impossible without liquid loss, even at low temperatures of about 40° C. and a virtually completely saturated water-vapour atmosphere.

It is known that a cover placed on the titer plate can reduce evaporation effects that occur. However, for sample volumes of a few microliters and to a greater extent for even smaller sample volumes, liquid transport from reaction cavities into adjacent cavities, which is favoured by capillary forces, occurs, which means that tight sealing of all individual reaction cavities can only be achieved with a disproportionately complex apparatus. A cover lying on spacers cannot prevent liquid loss of individual sample quantities. Even if the incubation is carried out in a virtually saturated water-vapour atmosphere, liquid transport from the individual reaction cavities cannot be prevented to an adequate extent by a laid-on cover.

The object of the invention is therefore to design a device of the generic type mentioned at the outset which prevents evaporation effects from individual reaction cavities with the lowest possible manufacturing complexity. The device should also enable substantial automation of the method steps necessary.

This object is achieved in accordance with the invention on the basis of a device for the parallel incubation of solutions having a retaining frame which accommodates a titer plate and having a cover plate which can be pressed on and which tightly plungers the titer plate in the retaining frame.

This facilitates a cover which tightly plungers the titer plate. The additional pressure is necessary and sufficient to prevent evaporated solvent from escaping from the space delimited by the titer plate, the retaining frame and the cover plate. The separation of the upper side of the titer plate from the cover plate pressed onto the retaining frame is advantageously extremely small, but direct contact is not possible. The small dimension of the thin air gap above the titer plate means that convection phenomena are prevented virtually completely. Without convection, however, evaporation effects, which are principally favoured thereby, hardly occur at all. For this reason, significant liquid transport of sample substances or solvents out of the individual reaction cavities does not occur either. As a consequence of the very small air volume above the titer plate, an equilibrium with a sufficiently saturated atmosphere already becomes established shortly after the tight sealing by the pressed-on cover plate. An equilibrium state of this type additionally inhibits evaporation of readily volatile liquids too, irrespective of the prespecified incubation temperature.

It is preferably provided that the retaining frame has, beneath the titer plate, a through cut-out which is matched to the dimensions of the titer plate and which can be tightly sealed by a plunger which can be moved perpendicular to the plane of the titer plate. An essential prerequisite for efficient and inexpensive performance of the parallel incubation of biological or chemical samples is substantial automation of all individual method steps. It is therefore possible, in a titer plate in which the individual reaction cavities are delimited at the bottom only by a sieve structure base, to suck the sample material or the solvent used off in a downward direction. An inserted titer plate can be filled from the top and emptied in a downward direction through the correspondingly matched cut-out in the retaining frame without the titer plate having to be moved or removed from the retaining frame.

Besides the actual incubation, subsequent method steps, such as, for example, quantitative analyses, can also be carried out in a completely automated manner. Since, owing to the low sample volume in the individual reaction cavities, even extremely small interfering effects could give an incorrect result in a sensitive manner, it is particularly advantageous to avoid any unnecessary contact with the titer plate.

During the incubation, the movable plunger is installed just below the titer plate. In a similar manner to the cover plate, the movable plunger reduces the sealed-off air volume beneath the titer plate and thus prevents evaporation effects and transport phenomena of the dispensed sample substances and the solvent.

The plunger can be moved into the position provided therefor and removed again in an automated manner. The entire retaining frame together with the inserted titer plates can be removed and used further in other laboratory instruments.

According to an embodiment of the inventive idea, it is proposed that the cover plate can be pressed tightly onto the retaining frame by screw, spring or clamp devices. Depending on the respective properties of the sample and of the solvent used, the minimum cover-plate pressure necessary can vary. At the same time, however, a sealing mechanism which can be released simply and quickly is advantageous for automated operation of the device. In particular, a screw connection of the cover plate to the retaining frame seals the titer plate sufficiently tightly even during extended incubation at greatly elevated temperature.

According to an advantageous embodiment of the inventive idea, it is proposed that the retaining frame has devices for temperature control. Many biological or chemical processes are affected by the ambient temperature. Controlled and reproducible incubation of the samples is therefore frequently only possible if the temperature of the titer plate can be pre-specified. If a non-temperature-controlled device is introduced, for incubation, into an incubator which is already at elevated temperature, it takes a correspondingly long time, depending on the temperature difference, until an equilibrium state has become established. However, even small temperature gradients within a titer plate favour evaporation effects and transport phenomena and result in mutual influencing of adjacent reaction cavities.

Temperature-control devices located in the retaining frame enable a uniform and constant temperature of the titer plate lying directly on top to be guaranteed. Forced temperature changes, as occur, for example, at the beginning and end of incubation, can thus be achieved significantly more quickly and in a significantly more controlled manner.

It is preferably provided that the cover plate has devices for temperature control. The temperature of the titer plate can also be controlled via a heatable cover plate. It is also possible to suppress condensation of sample material and solvent on the underside of the cover plate by increasing the temperature of the cover plate. This prevents, in particular, evaporated solvent from precipitating on the underside of the cover plate and individual drops then falling onto the titer plate in an uncontrolled manner.

If an essentially transparent cover plate is used, misting-up of the cover plate can be prevented by a correspondingly prespecified temperature of the cover plate, so that the individual reaction cavities of the titer plate are clearly visible at all times. This makes, for example, optical analytical methods during incubation possible without prior removal of the cover plate.

It is preferably provided that the retaining frame, besides the titer plate, has groove-like recesses for the accommodation of liquid solvent. After a titer plate has been filled with sample material and solvent, a certain amount of liquid evaporates, so that an equilibrium with the atmosphere, which is then sufficiently saturated, becomes established directly above the titer plate. Even if only small amounts of liquid evaporate owing to the small air volume above the titer plate, this can, however, greatly impair quantitative evaluations, or even render them impossible, owing to the likewise very low capacity of individual reaction cavities. If, however, liquid solvent is introduced into the groove-like recesses before the titer plates are placed in position or filled, this amount of liquid equally contributes proportionately to evaporation. The dimensions of the groove-like recesses can be selected in such a way that the liquid necessary for a saturated atmosphere evaporates very predominantly from the groove-like recesses. Evaporation effects from individual reaction cavities of the titer plate can additionally be reduced or prevented virtually completely.

According to an embodiment of the inventive idea, it is proposed that the cover plate has recesses for the accommodation of solvents above the titer plate. For example, a recess of this type can accommodate a solvent-soaked mat. In this way, a relatively large stock of solvent is available within the small, sealed air volume. The surface structure of the mat promotes evaporation of the liquid present therein. At the same time, unintentional dripping-out onto the titer plate is prevented.

It is advantageously provided that a plurality of titer plates can be inserted alongside one another into the retaining frame and can be tightly sealed by a cover plate which can be pressed on. Owing to the small dimensions of individual reaction cavities, a relatively large number of reaction cavities can be arranged even on a small titer plate. The manufacturing complexity and production costs increase greatly with increasing size of the titer plate. It is therefore in principle advantageous to use a plurality of small and more easily handled titer plates simultaneously instead of a single titer plate which is as large as possible. In this way, a very large number of individual reaction cavities can be used in parallel at only slightly increased effort.

The common cover plate pressed onto the retaining frame encloses each titer plate individually. Liquid or gas exchange between adjacent titer plates is not possible. In the case of a plurality of small titer plates, the segmented air volume above each titer plate is correspondingly small, meaning that only little liquid is able to evaporate.

According to an advantageous embodiment of the inventive idea, it is proposed that the movable plungers assigned to each titer plate are designed as plunger-shaped structures formed on a common base plate. In this way, the through cut-outs of the retaining frame beneath each titer plate can be opened and re-sealed simply and in a completely automatable manner. Complex devices for the controlled alignment and movement of individual plungers are thus superfluous. The respective stroke is the same for all plungers, so that each titer plate has essentially identical ambient conditions during incubation.

Further advantageous embodiments of the inventive idea are the subject-matter of further sub-claims.

Illustrative embodiments of the invention are explained in greater detail below and are shown in the drawing, in which:

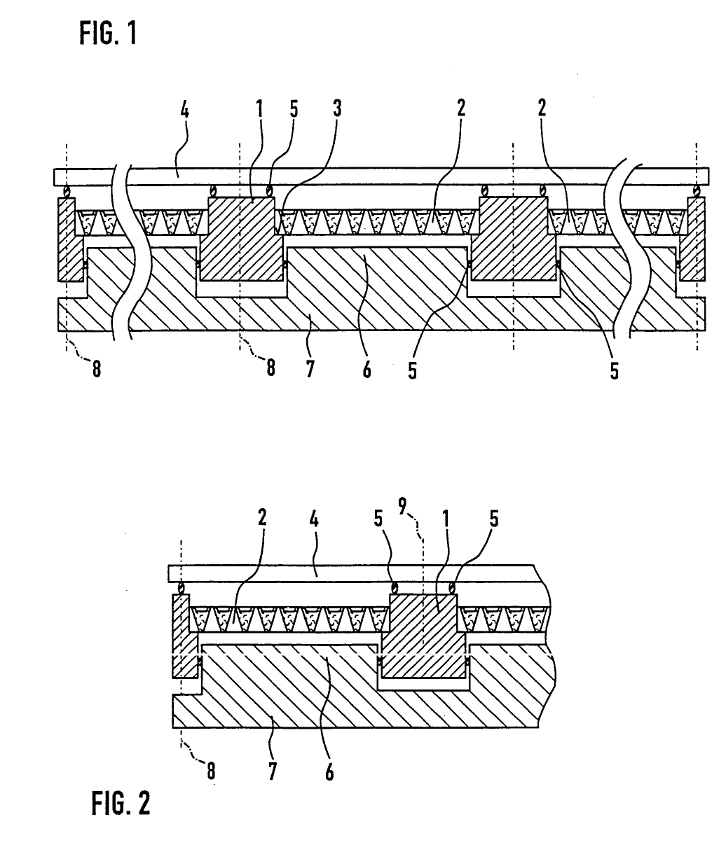

FIG. 1 shows a section through a retaining frame accommodating a plurality of titer plates,

FIG. 2 shows a section through a retaining frame of similar design with a cover plate attached thereto,

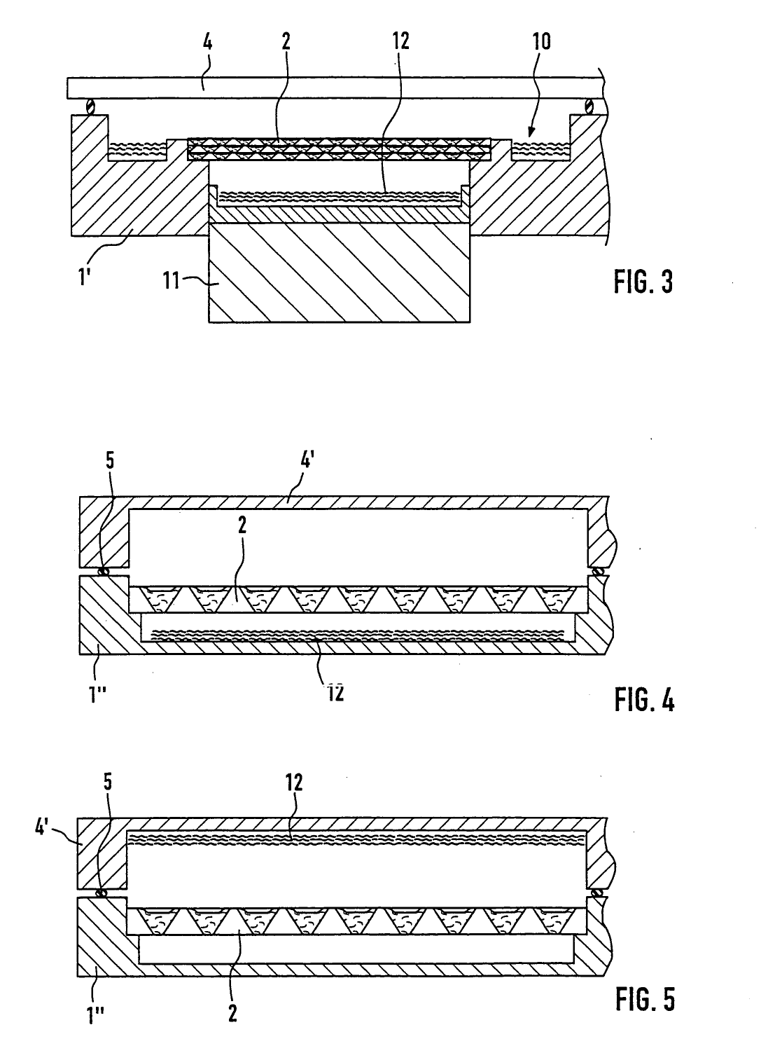

FIG. 3 shows a section through a retaining frame having a plurality of recesses for the accommodation of liquids, FIG. 4 shows a section through a retaining frame in which a solvent-soaked mat is installed in a recess beneath the titer plate,

FIG. 5 shows the retaining frame shown in FIG. 4, where the liquid-soaked mat is attached in a recess on the underside of the cover plate.

The device shown in FIGS. 1 and 2 for the parallel incubation of solutions has a plurality of titer plates 2 inserted into a retaining frame 1. Each titer plate 2 lies on lateral projections 3 of the retaining frame 1. Each titer plate 2 is completely surrounded individually by the retaining frame 1 on its side surfaces. The upper side of the titer plates 2 is located somewhat below the upper edge of the retaining frame 1. A continuous cover plate 4 is pressed onto the retaining frame 1 from above in such a way that each titer plate 2 is separately enclosed. A plurality of seals 5 are installed between the retaining frame 1 and the cover plate 4. Adequate sealing of the individual titer plates 2 is thereby achieved, even with a relatively low pressure of the cover plate 4 onto the retaining frame 1. In addition, damage to the cover plate 4 by direct contact with the retaining frame 1 is prevented.

Through cut-outs in the retaining frame 1 are located beneath each titer plate 2. These are sealed by plunger-shaped structures 6 formed on a continuous, one-piece base plate 7. Seals 5 are likewise installed between the retaining frame 1 and the plunger-shaped structures 6 formed on the one-piece base plate 7. The air volume surrounding a titer plate 2 above and below the titer plate 2 can thus be reduced to a minimum and tightly sealed-off.

The cover plate 4, the retaining frame 1 and the one-piece base plate 7 are pressed together by through screw connections 8. This can be achieved in a simple manner, for example by a threaded rod and wing nuts which can be screwed on from both sides. The separation of the through screw connections 8 from one another can be matched to the minimum pressure of the cover plate 4 onto the retaining frame 1 that is necessary for adequate sealing-off. In a simple embodiment, it is sufficient for, as shown in FIG. 1, a through screw connection 8 to be provided in each of the corners of each titer plate 2.

The one-piece base plate 7 may be made of dimensionally stable material, so that its attachment to the retaining frame 1 requires only little effort. FIG. 2 shows a consequently slightly modified illustrative embodiment of the device shown in FIG. 1, in which a plurality of through screw connections 8 are provided only on the outsides of the retaining frame 1. The cover plate 4 may additionally be pressed onto the retaining frame 1 by means of screw connections 9 on one side. Instead of a one-piece base plate 7 with plunger-shaped structures 6, it is also conceivable to use a plurality of plungers installed on a common base plate 7.

The retaining frame 1′ shown in FIG. 3 has groove-like recesses 10 which are arranged surrounding the inserted titer plate 2. The capacity of the groove-like recesses 10 is designed so that the proportion of liquid evaporating from a filled titer plate 2 is substantially reduced.

A movable plunger 11, which seals the through cut-out of the retaining frame 1′ beneath the titer plate 2, has, on the side facing the titer plate 2, a recess in which is located a liquid-soaked mat 12. Whereas the liquid from the groove-like recesses 10 of the retaining frame 1′ principally evaporates into the air volume above the titer plate 2, the space beneath the titer plate 2 is essentially moistened by the liquid-soaked mat 12 on the upper side of the movable plunger 11.

It is likewise conceivable to use a movable plunger 11 with-out recess and liquid-soaked mat 12 installed therein. A movable plunger of this type can then be pressed in, for example, a sprung manner onto the titer plate 2, which can be fixed in the retaining frame 1′. It is thus possible, for specific applications, to seal apertures located on the underside of the titer plate 2 by the movable plunger 11. Through a suitable choice of the spring force, the tightest possible sealing of the underside of the titer plate 2 can be achieved, but at the same time damage to the titer plate 2, which is usually sensitive, by excessive pressure forces is avoided.

It is also conceivable for the movable plunger 11 to have devices for temperature control. A movable plunger 11 located directly beneath the titer plate 2 or even in contact therewith may, owing to its size and position, be advantageous for rapid and precise temperature control of the titer plate 2.

FIGS. 4 and 5 show an essentially identical retaining frame 1″. A shallow recess, in which, as shown in FIG. 4, a liquid-soaked mat 12 is installed, is located beneath the inserted titer plate 2. However, the liquid-soaked mat 12 may also instead or in addition be installed in a recess of the cover plate 4′ provided for this purpose. The cover plate 4′ is pressed onto the retaining frame 1″ by means of screw, spring or clamp devices, which are not shown in the figure. Seals 5 installed between the cover plate 4′ and the retaining frame 1″ prevent gas or liquid exchange between adjacent titer plates 2 or with the environment.

In the case of the retaining frame 1″ shown in FIGS. 4 and 5, it is also possible for a plurality of titer plates 2 to be inserted alongside one another into the retaining frame 1″ and to be tightly sealed-off by the cover plate 4′ which can be pressed on.

1. Device for the parallel incubation of solutions, having a retaining frame (1, 1′, 1″) which accommodates a titer plate (2) and having a cover plate (4, 4′) which can be pressed on and which tightly seals the titer plate (2) in the retaining frame (1, 1′, 1″).

2. Device according to claim 1, characterised in that the retaining frame (1, 1′) has, beneath the titer plate (2), a through cut-out which is matched to the dimensions of the titer plate (2) and which can be tightly sealed by a plunger (11) which can be moved perpendicular to the plane of the titer plate (2).

3. Device according to claim 2, characterised in that the movable plunger (11) can be pressed in a sprung manner onto the titer plate (2), which can be fixed in the retaining frame (1, 1′).

4. Device according to claim 1, characterised in that the cover plate (4, 4′) can be pressed tightly onto the retaining frame (1, 1′, 1″) by screw, spring or clamp devices.

5. Device according to claim 1, characterised in that seals (5) can be installed between the retaining frame (1, 1′, 1″) and the cover plate (4, 4′).

6. Device according to claim 1, characterised in that seals (5) can be installed between the retaining frame (1, 1′) and the movable plunger (11).

7. Device according to claim 1, characterised in that the retaining frame (1, 1′, 1″) has devices for temperature control.

8. Device according to claim 1, characterised in that the movable plunger (11) has devices for temperature control.

9. Device according to claim 1, characterised in that the cover plate (4, 4′) has devices for temperature control.

10. Device according to claim 1, characterised in that the retaining frame (1′), has besides the titer plate (2), groove-like recesses (10) for the accommodation of liquid solvent.

11. Device according to claim 1, characterised in that the cover plate (4′) has recesses for the accommodation of solvent above the titer plate (2).

12. Device according to claim 1, characterised in that the retaining frame (1″) has recesses for the accommodation of solvent beneath the titer plate (2).

13. Device according to claim 2, characterised in that the movable plunger (11) has a recess for the accommodation of solvent on the side facing the titer plate (2).

14. Device according to claim 1, characterised in that a plurality of titer plates (2) can be inserted alongside one another into the retaining frame (1, 1′, 1″) and can be tightly sealed-off by the cover plate (4, 4′) which can be pressed on.

15. Device according to claim 14, characterised in that a plurality of movable plungers (11) are installed on a common base plate (7).

16. Device according to claim 14, characterised in that a plurality of movable plungers (11) are designed as plunger-shaped structures (6) formed on a common base plate (7).
